(19) United States
(12) Patent Application Publication
(10) Pub. No.: US 2024/0403570 A1
(43) Pub. Date: Dec. 5, 2024

(54) CREDENTIAL DETECTION FOR DATA LOSS PREVENTION WITH ONE-DIMENSIONAL CONVOLUTIONAL NEURAL NETWORKS

(71) Applicant: Palo Alto Networks, Inc., Santa Clara, CA (US)

(72) Inventors: Anirudh Mittal, Fremont, CA (US); Sujit Rokka Chhetri, Santa Clara, CA (US); Naresh Kumar Venkata Guntupalli, Fremont, CA (US); Yaser Karbaschi, San Jose, CA (US)

(21) Appl. No.: 18/325,424

(22) Filed: May 30, 2023

(51) Int. Cl. G06F 40/47; G06F 40/284

(52) U.S. Cl. CPC G06F 40/47; G06F 40/284

(57) ABSTRACT

A trained one-dimensional convolutional neural network (1D CNN) efficiently detects credentials that allow access to sensitive data across an organization. The 1D CNN has a lightweight architecture with one or more one-dimensional convolutional layers that capture semantic context of text data and a one-hot encoding embedding layer that takes unprocessed characters from documents as input. Lightweight architecture of the 1D CNN allows for high volume, fast detection of credentials for data loss prevention. The 1D CNN is trained on documents augmented with natural language processing techniques including token replacement, machine translation, token rearrangement, and text summarization.

### BACKGROUND

The disclosure generally relates to subclass G06F 21/00 and subclass G06F 21/62.

Credentials that allow potentially malicious access to sensitive data are stored, communicated, and present in running processes, storage media, channels of communication, etc. across organizations. Data sources that store these credentials include source code, configuration files, emails, messaging applications, traffic logs, Uniform Resource Locators (URLs), JavaScript Object Notation (JSON) files, etc. Credentials vary with respect to type and format, and documents containing credentials contain varying syntax before and after credentials. Often these data sources contain pseudo-credentials such as credential descriptors including credential keywords that do not actually comprise sensitive data.

### BRIEF DESCRIPTION OF THE DRAWINGS

Embodiments of the disclosure may be better understood by referencing the accompanying drawings.

FIG. 1 is a schematic diagram of an example system for training and deploying a one-dimensional (1D) CNN for detection of credentials in potentially sensitive documents across an organization.

FIG. 2 is a schematic diagram of an example architecture of a 1D CNN for efficiently detecting credentials in potentially sensitive documents.

FIG. 3 is a flowchart of example operations for detecting credentials in potentially sensitive documents with a trained 1D CNN.

FIG. 4 is a flowchart of example operations for training a 1D CNN to detect credentials in documents for DLP.

FIG. 5 depicts an example computer system with a trained 1D CNN for credential detection and a CNN trainer.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

A “document” as used herein refers to text data that are extracted from networks, endpoint devices, storage devices, or other storage media across an organization. The text data within a document comprises a sequence of allowable characters, and in some instances non-allowable characters can be replaced by a generic placeholder character. Documents can be processed, logged, or stored on various types of storage media in persistent or temporary storage according to different embodiments.

A “credential” as used herein refers to a string that enables access to sensitive data and/or resources of an organization. Credentials can include passwords, Application Programming Interface (API) tokens, private keys, access tokens, digital credentials, etc. As such, attack vectors accessed via exposed credentials to a malicious actor vary in stages within an attack framework. For instance, a password can allow access during an initial access stage, access tokens can allow access during an execution/persistence stage, digital credential can allow access during a credential access stage, etc.

### Overview

Due to semantic context, often documents without sensitive data are detected as potentially sensitive documents by regular expressions, for instance when the potentially sensitive documents comprise descriptors of credentials and not credentials themselves. Moreover, documents containing credentials can be unstructured so that a typical parsing or pattern matching system has no indication of where to search within documents for the credentials. The use of regular expressions and other pattern matching techniques for detection of credentials in potentially sensitive documents suffers from rigidity that loses semantic context and fails to detect complex credential syntax. To boot, data loss prevention (DLP) across an organization is an online credential detection task involving thousands or hundreds of thousands of documents per day, and as such any model for credential detection should be lightweight while also compensating for the deficiencies of regular expressions and other rigid pattern detection techniques.

A one-dimensional (1D) convolutional neural network (CNN) disclosed herein comprises a lightweight architecture that accurately and efficiently detects credentials in documents while accounting for semantic context and complex syntax. The 1D CNN comprises a one-hot encoding embedding layer that takes unprocessed, truncated documents as inputs without additional natural language processing and generates character-level encodings. The 1D CNN further comprises one or more 1D convolutional layers that apply 1D kernels to the character-level encodings, capturing semantic context. The use of a machine learning model such as a CNN allows for detection of complex syntax beyond what is captured in typical regular expressions, and the 1D CNN involves minimal preprocessing and has a low number of internal parameters, resulting in efficient credential detection. Training data for the 1D CNN are augmented with natural language processing techniques that account for semantic context, multiple languages, and rearrangement of tokens which further enhances detection quality. Once deployed, the 1D CNN allows for efficient and accurate credential detection and is efficiently updated according to its low parameter, lightweight architecture.

### Example Illustrations

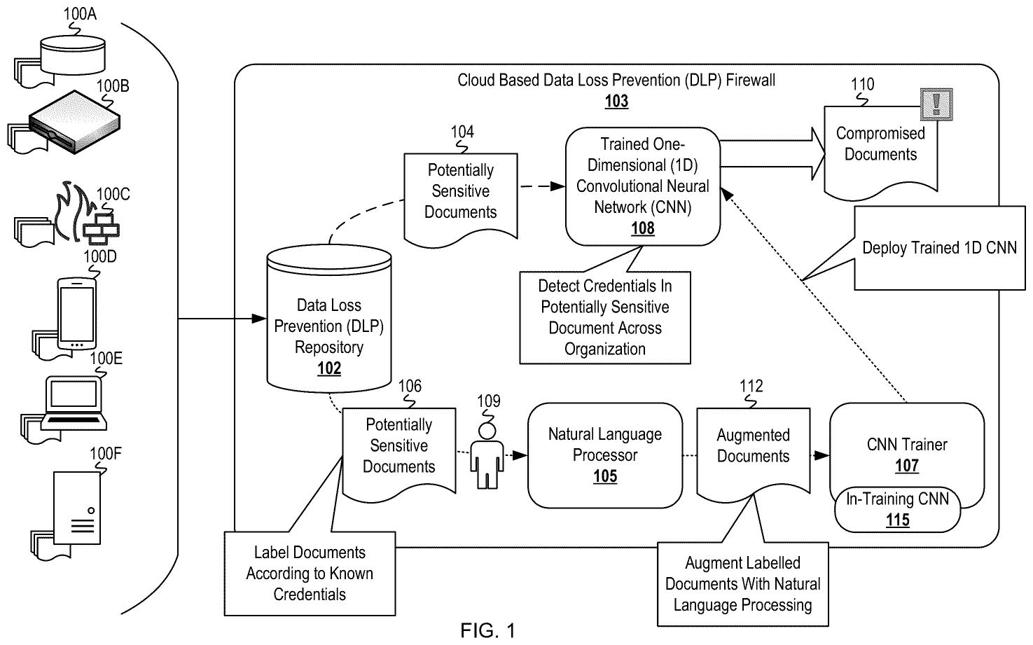

FIG. 1 is a schematic diagram of an example system for training and deploying a 1D CNN for detection of credentials in potentially sensitive documents across an organization. FIG. 1 is delineated into two pipelines: a lower pipeline with shorter dashed lines for training a 1D CNN with augmented training data, and an upper pipeline with longer dashed lines for deploying a trained 1D CNN 108. Training and deployment of the trained 1D CNN 108 can occur according to a schedule or as additional documents are labelled as comprising or not comprising credentials for training data. An initial iteration of the lower pipeline trains a first version of the trained 1D CNN 108 while additional iterations of the lower pipeline occur for updating the trained 1D CNN 108 while deployed.

A DLP repository 102 stores potentially sensitive documents across an organization such as documents detected at a database 100A, a storage medium 100B, a firewall 100C, devices 100D-E, and a server 100F. The potentially sensitive documents comprise documents stored in memory, documents communicated across a public or private network, documents parsed or logged from processes running on endpoint devices, etc. While depicted as a repository, the DLP repository 102 can encompass local memory at a firewall, random-access memory, a hard drive at an endpoint device, a database of training data, or any other storage medium monitored by a cloud based DLP firewall (firewall) 103 and can comprise multiple distributed storage media. Moreover, although the firewall 103 is characterized as cloud based, the firewall 103 can be running locally on an endpoint device or server.

The firewall 103 comprises a natural language processor 105 that receives potentially sensitive documents 106 from the DLP repository 102 that are labelled by a domain-level expert 109 or by a model for pattern matching of credential patterns, such as regular expressions. Each label indicates whether a document comprises credentials. The DLP repository 102 can communicate the potentially sensitive documents 106 as they are monitored by the organization for DLP or can periodically communicate the potentially sensitive documents 106 according to a schedule or based on a prompt by an administrator to initiate model training. The potentially sensitive documents 106 can be stored in a separate database of training data prior to model training. One or more models and/or consensus verdicts of models can be used to label the potentially sensitive documents 106.

The natural language processor 105 generates augmented documents 112 from the potentially sensitive documents 106. Augmenting the potentially sensitive documents 106 generates additional training data and also varies context and arrangement of the training data which provides robustness to varying context and order of credentials during model training. The augmented documents 112 comprise copies of the potentially sensitive documents 106 with transformations using various natural language processing techniques, and each of the augmented documents 112 has a same label as the corresponding one of the potentially sensitive documents 106 from which it was generated. The natural language processing techniques used for augmentation can include translating tokens into one or more distinct (e.g., non-English when the potentially sensitive documents 106 are in English) languages, processing documents with text summarization, replacing tokens with semantically similar words, rearranging tokens, etc. Document translation can be performed by a machine learning model with an encoder-decoder architecture (e.g., a recurrent neural network) and/or attention mechanisms, and a separate machine learning model can be used to detect the language of documents. Processing of documents with text summarization can also be performed with an encoder-decoder architecture or other recurrent neural network architecture and can comprise processing with extractive text summarization to identify important tokens/sentences or abstractive text summarization to generate new sentences/tokens. Documents can be processed via abstractive text summarization with other model architectures such as generative adversarial networks. Token replacement and rearrangement can be performed uniformly at random on choices of tokens and pairs of tokens, respectively, according to a fixed rate (e.g., 10%). Semantically similar words for token replacement can be determined according to word embeddings (e.g., word2vec) for a dictionary of words using a lookup function.

The CNN trainer 107 receives the augmented documents 112 and initializes and trains an in-training 1D CNN 115 to generate the trained 1D CNN 108. The CNN trainer 107 can randomly initialize internal parameters of the in-training 1D CNN 115 before its training according to its architecture (i.e., size and type of layers). The CNN trainer 107 trains the in-training 1D CNN 115 to predict whether documents comprise credentials using the augmented documents 112 and corresponding labels. The CNN trainer 107 trains the in-training 1D CNN 115 in batches and epochs until training criteria are satisfied, which for instance may include a criterion(a) that a threshold number of epochs have occurred, that training/testing/validation error are sufficiently small, that internal parameters of the in-training 1D CNN 115 converge across batches, etc. Once trained, the CNN trainer 107 deploys the trained 1D CNN 108 to detect credentials for DLP.

Once trained, the trained 1D CNN 108 receives potentially sensitive documents 104 from the DLP repository 102 and detects those documents comprising credentials as compromised documents 110. According to different types of storage media from which documents are extracted/monitored by the firewall 103, the trained 1D CNN 108 can be deployed inline at a firewall monitoring a network, deployed at a firewall that monitors processes running at an endpoint device, deployed in the cloud monitoring security zones including databases with variable access rights and security policies, etc. The potentially sensitive documents 104 are input to the trained 1D CNN 108 without preprocessing, which reduces latency of detection of documents with credentials at high volume. Additionally, the trained 1D CNN 108 can be deployed inline for detection of credentials in documents prior to being introduced to a potentially exposed network context.

Due to the effectiveness of architecture of the trained 1D CNN 108 at detecting credentials with complex syntax and incorporation of context information, the compromised documents 110 detected by the trained 1D CNN 108 have reduced false positives and false negatives compared to detecting compromised documents with regular expressions. To exemplify, a regular expression may detect a non-sensitive credential such as a password of an online meeting, a description of a credential without the credential itself, or a blank password from a command line such as an empty superuser login request:
% su
Password:
%
The trained 1D CNN 108 is effective at classifying documents containing such non-sensitive credentials as not comprising credentials. The trained 1D CNN 108 is also effective at classifying documents comprising credentials with complex syntax as comprising credentials, for instance the following examples:
{“password1”: “newpass123”, “password2”: “newpass123” }, follow=True selfclient.post(url, {‘password1’: ‘password1’, ‘password2’: ‘password1’}u1,_:=url.Parse(“nats://user1:pwd1@host1:2345”)
and other examples with varying types of syntax such as JSON syntax.

Based on detecting the compromised documents 110, the firewall 103 performs corrective action. The corrective action can comprise blocking communications of compromised documents, deleting compromised documents from non-secure storage, throttling exposed channels of communication, etc. The firewall 103 can further display to a user an alert that indicates the compromised documents 110 and the section of the compromised documents 110 comprising credentials. Each compromised document can be scored for severity according to sensitivity of the credentials, security level of systems accessible by the credentials, etc.

During training and deployment, the augmented documents 112 and potentially sensitive documents 104 can be truncated to a fixed length (e.g., 1000 characters) according to an input size for the trained 1D CNN 108. While depicted as a 1D CNN, any machine learning model that can efficiently detect credentials in documents can be deployed by the firewall. For highly sensitive documents, heavyweight models such as Bidirectional Encoder Representations from Transformers models can be deployed instead.

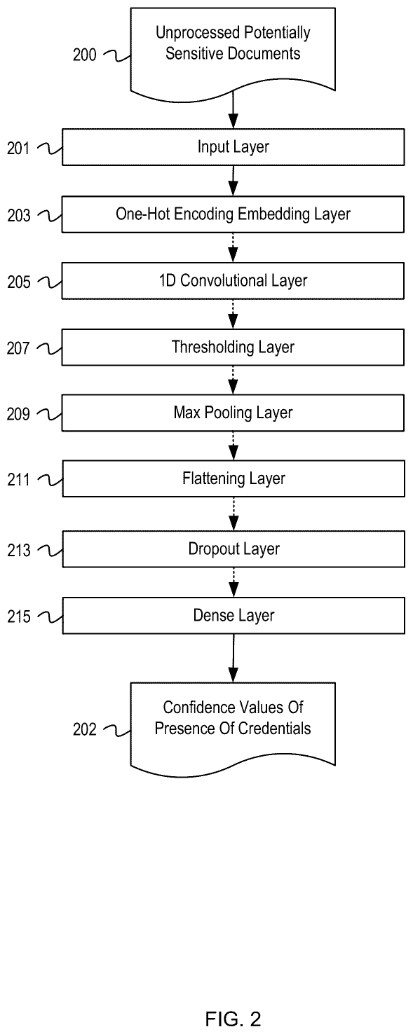

FIG. 2 is a schematic diagram of an example architecture of a 1D CNN for efficiently detecting credentials in potentially sensitive documents. An input layer 201 receives unprocessed potentially sensitive documents 200 for DLP. The input layer 201 feeds into a one-hot encoding layer 203 that encodes each character from the input layer 201 as a vector of all zeros with an entry with a value of one corresponding to the character. The vectors have length equal to the alphabet of admissible characters, e.g., a fixed list of American Standard Code for Information Interchange (ASCII) characters. The one-hot encoding layer 203 can replace non-admissible ASCII characters with a placeholder character prior to character encoding. The one-hot encoding layer 203 feeds into a 1D convolutional layer 205. Each of the subsequent layers including the 1D convolutional layer 205, a thresholding layer 207, a max pooling layer 209, a flattening layer 211, a dropout layer 213, and a dense layer 215 are depicted as connected with dashed arrows. This indicates that each of these layers can occur interchangeably in any order, can occur multiple times, and can vary with respect to length and internal parameters. A final dense layer outputs confidence values of presence of credentials 202 in each of the unprocessed potentially sensitive documents 200.

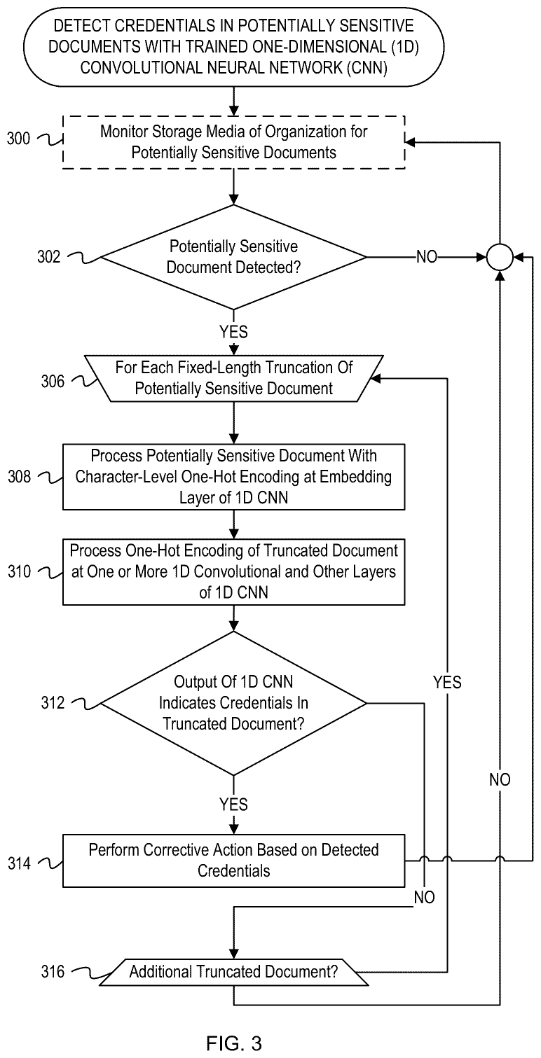

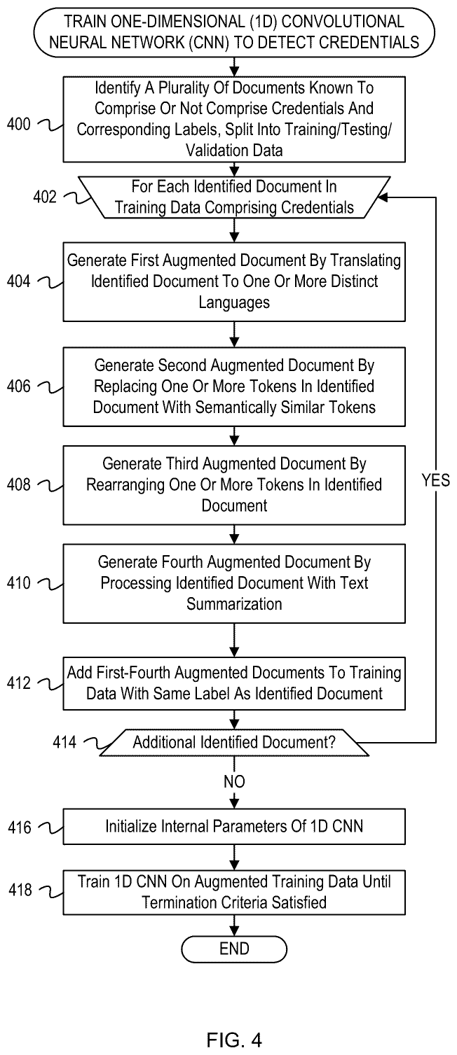

FIGS. 3-4 are flowcharts of example operations for training and deploying a 1D CNN to detect credentials in documents for DLP. The example operations are described with reference to a cloud based DLP firewall (firewall), a natural language processor, a trained 1D CNN (1D CNN), and a CNN trainer (trainer) for consistency with the earlier figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for detecting credentials in potentially sensitive documents with a trained 1D CNN. At block 300, the firewall monitors one or more storage media of an organization for potentially sensitive documents. Although described as a single entity, the firewall can correspond to multiple processes running on multiple devices and, in some embodiments, in distributed computing environments. For instance, the firewall can be running in the cloud to monitor internal and external network communications, on databases/servers to monitor data storage, and on endpoint devices to monitor processes. Monitoring the organization can occur according to a policy specified by the organization, for instance the organization can define security zones comprising ports/IP addresses as well as devices/databases to be monitored. Different security zones can have different policies for types of documents to be monitored. or instance, security zones with private storage of user data can indicate monitoring of data storage in addition to network communications, while security zones with public storage of non-sensitive data can indicate monitoring only of external network communications. The storage media can vary across security zones, for instance local memory at a firewall in the cloud, a database on a server, a hard drive on an endpoint device, a process stack, etc. Block 300 is depicted with a dashed outline to indicate that the firewall continuously monitors the one or more storage media of the organization for potentially sensitive documents for DLP until an external trigger (e.g., an administrator or user) intervenes, for instance by modifying security settings.

At block 302, the firewall determines whether a potentially sensitive document has been detected. Potentially sensitive documents can comprise documents communicated to/from exposed Internet Protocol addresses and/or ports, documents stored in databases/servers that have security exposure, documents corresponding to processes running on an endpoint, etc. Documents can be determined as potentially sensitive according to one or more policies for a corresponding security zone in which the documents are present, for instance as defined by the organization. The firewall can evaluate sensitivity based on security exposure from instances where documents are monitored. In some embodiments, all documents detected across the organization are determined to be potentially sensitive. If the firewall determines a document is potentially sensitive, operational flow proceeds to block 306. Otherwise, operational flow returns to block 300.

At block 306, the 1D CNN iterates through fixed-length truncations of the potentially sensitive document. The fixed-length truncations have a length (e.g., 1000 characters) that matches an input size of the 1D CNN.

At block 308, the 1D CNN processes the potentially sensitive document with character-level one-hot encoding at an embedding layer of the 1D CNN. The embedding layer maps each character in the potentially sensitive document to a vector of all zeroes except an entry with a value of one corresponding to the character. The vector has a length equal to the number of admissible characters (e.g., a specified set of ASCII characters), with each entry corresponding to a unique character.

At block 310, the 1D CNN processes the one-hot encoding of the truncated document at one or more 1D convolutional layers and other layers. Each 1D convolutional layer comprises a kernel operation on a 1D vector and thus captures contextual information across characters within each window the kernel captures. The other layers include thresholding layers, max pooling layers, flattening layers, dropout layers, and dense layers that can vary with respect to order, size, and number of instances. A final dense layer outputs a confidence value that the truncated document comprises credentials.

At block 312, the firewall determines whether the confidence value output by the 1D CNN indicates credentials in the truncated document. For instance, the firewall can determine that the confidence value indicates credentials if the confidence value is above a threshold confidence value and can determine that the confidence value does not indicate credentials otherwise. If the output indicates credentials, operational flow proceeds to block 314. Otherwise, operational flow skips to block 316.

At block 314, the firewall performs corrective action based on the detected credentials. The corrective action can comprise deleting the document from memory, blocking a channel of communication where the document was detected, terminating processes associated with the document, etc. Additionally, the firewall can indicate the document to a user display to show the credentials in association with metrics associated with security exposure. Operational flow returns to block 300. Although depicted as terminating iterations through truncated documents once credentials are detected and corrective action is performed, the firewall can alternatively iterate through all truncated documents to detect all instances of credentials in the document, for instance to display instances of credentials to a user.

At block 316, the 1D CNN continues iterating through truncated documents. If there is an additional truncated document, operational flow returns to block 306. Otherwise, operational flow returns to block 300.

FIG. 4 is a flowchart of example operations for training a 1D CNN to detect credentials in documents for DLP. At block 400, the firewall identifies a plurality of documents known to comprise or not comprise credentials and corresponding labels and splits the identified plurality of documents into training/testing/validation data. The firewall identifies documents in contexts for which the trained 1D CNN (1D CNN) will be deployed. For instance, the firewall can identify documents from an organization in contexts of data exposure for DLP, for instance according to security zones defined by the organization in which potentially sensitive data are stored/communicated. The firewall can identify and store the plurality of documents until a sufficient number of documents for training have been identified. The labels can be determined using other credential detection models such as regular expressions or can be determined by a domain-level expert. The firewall can split the identified documents into training and testing data according to a desired ratio (e.g., 80% training data/10% testing data/10% validation data) and can choose training/testing data uniformly at random from the identified documents.

At block 402, the natural language processor begins iterating through identified documents in the training data comprising credentials. Depending on the type and amount of training data desired for the 1D CNN, the natural language processor can iterate through a subset of the training data, for instance types of documents with higher security exposure that will result in higher accuracy credential detection.

At block 404, the natural language processor generates a first augmented document by translating the identified document into one or more distinct languages. The natural language processor can tokenize the identified document to extract tokens and detect a language of the document with a machine learning model, for instance a dictionary-based model that count vectorizes tokens in the identified document and compares high frequency tokens with dictionaries of various languages. An additional machine learning model, for instance a sequence-to-sequence based model can then translate the tokens in the identified document to the one or more distinct languages. The one or more distinct languages can comprise languages not present in the identified document but included in a list that can be provided by a user or organization. Alternatively, the list of languages can be determined as all languages present in the training data, for instance, by tokenizing every identified document and determining all languages present.

At block 406, the natural language processor generates a second augmented document by replacing one or more tokens in the identified document with semantically similar tokens. For instance, the natural language processor can generate word embeddings for tokens in the identified document and can identify tokens in a dictionary with close word embeddings. Tokens can be replaced uniformly at random according to a fixed subsampling rate, e.g., 10%.

At block 408, the natural language processor generates a third augmented document by rearranging one or more tokens in the identified document. The natural language processor can randomly permute pairs or sets of tokens. Alternatively, the natural language processor can identify sentences in the identified document based on punctuation and can randomly permute sentences and/or paragraphs instead.

At block 410, the natural language processor generates a fourth augmented document by processing the identified document with text summarization. The natural language processor can process the identified document with extractive or abstractive summarization using sequence-to-sequence modeling. Other machine learning techniques for determining semantic context of the identified document and representing the document in a compacted or extended form based on the semantic context are anticipated.

At block 412, the natural language processor adds the first to fourth augmented documents to the training data with the same label as the identified document. Additional or alternative data augmentations are anticipated. For instance, tokens can be randomly removed, data augmentations can be combined, etc.

At block 414, the natural language processor continues iterating through identified documents in the training data comprising credentials. If there is an additional identified document, operational flow returns to block 402. Otherwise, operational flow proceeds to block 416.

At block 416, the trainer initializes the internal parameters of a 1D CNN. The internal parameters are initialized according to size and type of internal layers of the 1D CNN. Some internal layers such as flattening or max pooling layers do not have internal parameters to initialize.

At block 418, the trainer trains the 1D CNN on the augmented training data until termination criteria are satisfied. Training occurs across batches and epochs, and the batches can be subsampled uniformly at random from the augmented training data at a rate that depends on architecture of the 1D CNN and the amount of augmented training data (e.g., 10%). The training termination criteria can comprise a criterion(a) that a threshold number of epochs has occurred, that training/testing/validation error are sufficiently low, that internal parameters of the 1D CNN converge across iterations, etc. Once trained, the firewall deploys the trained 1D CNN in the context of DLP for the organization.

### Variations

1D CNNs are described variously herein as being deployed for efficient and accurate detection of credentials in potentially sensitive documents. Various other machine learning architectures for text classification are anticipated, including recurrent neural network architectures, encoder-decoder architectures, etc. Different machine learning models can be deployed in different security zones across an organization according to security levels. For instance, machine learning models with heavier architectures such as a Bidirectional Encoder Representations from Transformations model can be deployed for security zones where increased accuracy of credential detection is desired.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, once corrective action is performed based on detected credentials at block 314 of FIG. 3, operational flow can alternatively return to block 300 and skip additional iterations of truncated documents. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

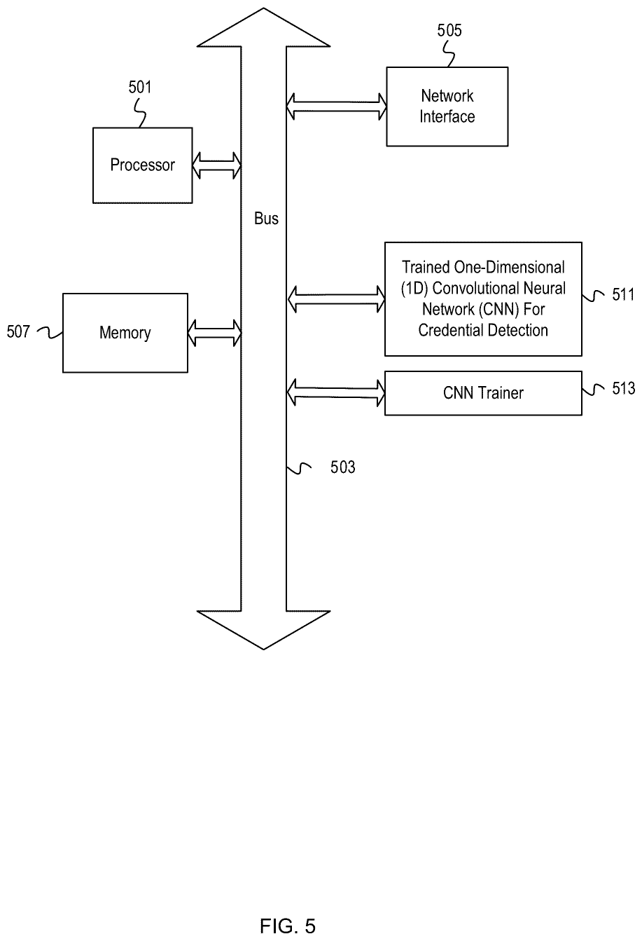

FIG. 5 depicts an example computer system with a trained 1D CNN for credential detection and a CNN trainer. The computer system includes a processor 501 (possibly including multiple processors, multiple cores, multiple nodes, and/or implementing multi-threading, etc.). The computer system includes memory 507. The memory 507 may be system memory or any one or more of the above already described possible realizations of machine-readable media. The computer system also includes a bus 503 and a network interface 505. The system also includes a trained 1D CNN for credential detection (1D CNN) 511 and a CNN trainer 513. The 1D CNN 511 detects credentials in documents across an organization and has a lightweight architecture for efficient and possibly inline credential detection without preprocessing of inputs. The 1D CNN 511 comprises an embedding layer that one-hot encodes character input and one or more 1D convolutional layers. The CNN trainer 513 augments documents with natural language processing, such as text translation, token rearrangement, token replacement based on semantics, and/or text summarization. The CNN trainer 513 additionally labels the augmented documents based on whether the original documents contained credentials. The CNN trainer 513 trains the 1D CNN 511 to detect credentials in documents across the organization. Any one of the previously described functionalities may be partially (or entirely) implemented in hardware and/or on the processor 501. For example, the functionality may be implemented with an application specific integrated circuit, in logic implemented in the processor 501, in a co-processor on a peripheral device or card, etc. Further, realizations may include fewer or additional components not illustrated in FIG. 5 (e.g., video cards, audio cards, additional network interfaces, peripheral devices, etc.). The processor unit 501 and the network interface 505 are coupled to the bus 503. Although illustrated as being coupled to the bus 503, the memory 507 may be coupled to the processor 501.

1. A method comprising:
training a convolutional neural network to detect credentials in documents, wherein training the convolutional neural network comprises,
identifying a plurality of documents and a plurality of labels indicating whether each of the plurality of documents comprises one or more credentials;
augmenting the plurality of documents with natural language processing to generate a plurality of augmented documents at least comprising the plurality of documents; and
training the convolutional neural network with the plurality of augmented documents and the plurality of labels; and
deploying the trained convolutional neural network to detect credentials for data loss prevention.

2. The method of claim 1, wherein the credentials comprise at least one of passwords, application programming interface tokens, access tokens, user credentials, private keys, and Privacy-Enhanced Mail files.

3. The method of claim 1, wherein the convolutional neural network comprises one or more one-dimensional convolutional layers.

4. The method of claim 3, wherein the convolutional neural network further comprises an embedding layer prior to a first of the one or more one-dimensional convolutional layers, further comprising processing a document at the embedding layer and the first one-dimensional convolutional layer, wherein processing the document at the embedding layer and the first one-dimensional convolutional layer comprises,
truncating the document into fixed-length subdocuments; and
for each fixed-length subdocument of the document,
one-hot encoding characters in the subdocument at the embedding layer; and
applying a one-dimensional kernel in a sliding window to the one-hot encoding of the characters in the subdocument.

5. The method of claim 1, wherein augmenting the plurality of documents with natural language processing comprises at least one of translating one or more of the plurality of documents to different languages, replacing tokens in the plurality of documents with different tokens that are semantically similar, rearranging tokens in sentences in the plurality of documents, and processing one or more of the plurality of documents with text summarization.

6. The method of claim 1, wherein deploying the trained convolutional neural network to detect credentials for data loss prevention comprises,
detecting documents in network contexts with potential data leakage exposure based on monitoring one or more storage media in the network contexts.
inputting the detected documents into the trained convolutional neural network to obtain confidence values that corresponding ones of the detected documents comprise credentials; and
indicating one or more detected documents corresponding to confidence values above a threshold confidence value as comprising sensitive data.

7. The method of claim 5, wherein the documents in network contexts with potential data leakage exposure comprise at least one of documents at rest, documents inline, documents used by a software-as-a-service or an infrastructure-as-a-service, and documents in use at endpoint devices.

8. A non-transitory machine-readable medium having program code stored thereon, the program code comprising instructions to:
detect credentials in documents for data loss prevention with a machine learning model, wherein the instructions to detect credentials comprise instructions to,
identify one or more documents comprising potentially sensitive data; and
input the one or more documents into the machine learning model to obtain one or more verdicts indicating the presence of credentials in corresponding documents of the one or more documents as outputs, wherein the machine learning model was trained on documents augmented with natural language processing and labels indicating whether each of the documents comprises credentials; and
indicate at least a subset of the one or more documents in association with the one or more verdicts indicating the presence of credentials in corresponding documents.

9. The non-transitory machine-readable medium of claim 8, wherein the credentials comprise at least one of passwords, application programming interface tokens, access tokens, user credentials, private keys, and Privacy-Enhanced Mail files.

10. The non-transitory machine-readable medium of claim 8, wherein the machine learning model comprises a convolutional neural network, wherein the convolutional neural network comprises one or more one-dimensional convolutional layers.

11. The non-transitory machine-readable medium of claim 10, wherein the convolutional neural network further comprises an embedding layer prior to a first of the one or more one-dimensional convolutional layers, further comprising instructions to process a document at the embedding layer and the first one-dimensional convolutional layer, wherein the instructions to process a document at the embedding layer and the first one-dimensional convolutional layer comprise instructions to, truncate the document into a fixed-length subdocument; and
for each fixed-length subdocument of the document,
one-hot encode characters in the subdocument at the embedding layer; and
apply a one-dimensional kernel in a sliding window to the one-hot encoding of the characters in the subdocument.

12. The non-transitory machine-readable medium of claim 8, wherein the documents augmented with natural language processing comprise at least one of documents translated to different languages, documents with tokens replaced by semantically similar tokens, documents with one or more tokens rearranged, and documents processed with text summarization.

13. The non-transitory machine-readable medium of claim 8, wherein the one or more documents comprising potentially sensitive data comprise at least one of documents at rest, documents inline, documents used by a software-as-a-service or an infrastructure-as-a-service, and documents in use at endpoint devices.

14. An apparatus comprising:
a processor; and
a machine-readable medium having instructions stored thereon that are executable by the processor to cause the apparatus to,
identify a plurality of documents and a plurality of labels indicating whether each of the plurality of documents comprises credentials;
augment the plurality of documents with natural language processing to obtain a plurality of augmented documents at least comprising the plurality of documents;
train a convolutional neural network to detect credentials in documents based, at least in part, on the plurality of augmented documents and corresponding ones of the plurality of labels; and
deploy the trained convolution neural network to detect credentials in potential sensitive documents for data loss prevention.

15. The apparatus of claim 14, wherein the credentials comprise at least one of passwords, application programming interface tokens, access tokens, user credentials, private keys, and Privacy-Enhanced Mail files.

16. The apparatus of claim 14, wherein the convolutional neural network comprises one or more one-dimensional convolutional layers.

17. The apparatus of claim 16, wherein the convolutional neural network further comprises an embedding layer prior to a first of the one or more one-dimensional convolutional layers, further comprising instructions executable by the processor to cause the apparatus to process a document at the embedding layer and the first one-dimensional convolutional layer, wherein the instructions to process the document at the embedding layer and the first one-dimensional convolutional layer comprise instructions executable by the processor to cause the apparatus to, truncate the document into a fixed-length subdocument; and
for each fixed-length subdocument of the document,
one-hot encode characters in the subdocument at the embedding layer; and
apply a one-dimensional kernel in a sliding window to the one-hot encoding of the characters in the subdocument.

18. The apparatus of claim 14, wherein the instructions executable by the processor to cause the apparatus to augment the plurality of documents with natural language processing comprise instructions to at least one of translate one or more of the plurality of documents to different languages, replace tokens in the plurality of documents with different tokens that are semantically similar, rearrange tokens in sentences in the plurality of documents, and process one or more of the plurality of documents with text summarization.

19. The apparatus of claim 14, wherein the instructions executable by the processor to cause the apparatus to deploy the trained convolutional neural network to detect credentials in potentially sensitive documents for data loss prevention comprise instructions to,
detect documents in network contexts with potential data leakage exposure based on monitoring one or more storage media in the network contexts;
input the detected documents into the trained convolutional neural network to obtain confidence values that corresponding ones of the detected documents comprise credentials; and
indicate one or more detected documents corresponding to confidence values above a threshold confidence value as comprising sensitive data.

20. The apparatus of claim 19, wherein the documents in network contexts with potential data leakage exposure comprise at least one of documents at rest, documents inline, documents used by a software-as-a-service or an infrastructure-as-a-service, and documents in use at endpoint devices.
